(19) United States
(12) Patent Application Publication
(10) Pub. No.: US 2010/0296103 A1
(43) Pub. Date: Nov. 25, 2010

(54) OPTICAL MICRORESONATOR

(76) Inventors: Terry L. Smith, Roseville, MN (US); Barry J. Koch, Woodbury, MN (US); Yasha Yi, New York, NY (US)

Correspondence Address: 3M INNOVATIVE PROPERTIES COMPANY, PO BOX 33427, ST. PAUL, MN, 55133-3427, US

(21) Appl. No.: 12/742,819

(22) PCT Filed: Nov. 4, 2008
(86) PCT No.: PCT/US08/82325

§ 371 Date: Jul. 21, 2010

Related U.S. Application Data
(60) Provisional application No. 60/988,227, filed on Nov. 15, 2007.

(51) Int. Cl. G01B 9/02; H01S 3/063; G02B 6/12

(52) U.S. Cl. 356/480; 359/341.1

(57) ABSTRACT

An optical microresonator system and a sensor are disclosed. The optical microresonator system includes an optical waveguide and an optical microresonator that is directly optically coupled to the optical waveguide. The optical microresonator further includes an optical microcavity that is core coupled to the optical microresonator but not to the optical waveguide.

### FIELD OF THE INVENTION

This invention generally relates to optical devices. The invention is particularly applicable to optical devices such as optical sensors that incorporate microresonators.

### BACKGROUND

Microresonators have received increasing attention in various applications such as optical switching, wavelength filtering, optical lasers, light depolarization, and chemical and biological sensing.

Some known microresonator constructions involve placing a glass spherical microresonator in close proximity to an optical waveguide such as an optical fiber. In such cases, optical energy can transfer between the resonator and the optical waveguide by evanescent coupling. The separation between the resonator and the optical waveguide is typically less than one micron and must be controlled with precision to provide reproducible performance. Other forms of microresonators include disk- or ring-shaped microresonators.

### SUMMARY OF THE INVENTION

Generally, the present invention relates to optical devices. The present invention also relates to optical sensors that include one or more microresonators.

In one embodiment of the invention, an optical microresonator system includes an optical waveguide and an optical microresonator that is directly optically coupled to the optical waveguide. The optical microresonator further includes an optical microcavity that is core coupled to the optical microresonator but not to the optical waveguide.

In another embodiment of the invention, an optical sensor includes a microresonator system that includes an optical waveguide, an optical microresonator that is directly optically coupled to the optical waveguide, and an optical microcavity that is optically coupled to the optical microresonator but not to the optical waveguide. The optical sensor further includes a light source that is in optical communication with the optical waveguide and emits light at a wavelength that corresponds to a resonant mode of the microresonator system. The optical sensor further includes a detector that is in optical communication with the microresonator system. The detector detects a characteristic of the resonant mode. The characteristic of the resonant mode changes when an analyte is brought proximate the microresonator system. The detector detects the change.

In another embodiment of the invention, an optical microresonator system includes an optical waveguide that supports a guided mode; an optical microresonator that supports a first resonant mode that is directly excited by the guided mode; and an optical microcavity that supports a second resonant mode that is directly excited by the first resonant mode but not by the guided mode.

In another embodiment of the invention, an optical microresonator system includes an optical waveguide; a first optical microcavity that is core coupled to the optical waveguide; an optical microresonator that is core coupled to the first optical microcavity but not to the optical waveguide; and a second optical microcavity that is core coupled to the optical microresonator but not to the first optical microcavity.

### BRIEF DESCRIPTION OF DRAWINGS

The invention may be more completely understood and appreciated in consideration of the following detailed description of various embodiments of the invention in connection with the accompanying drawings, in which:

FIG. 1 is a schematic top-view of a microresonator system;

FIG. 2 is a schematic side-view of the microresonator system in FIG. 1;

FIG. 3 is a schematic top-view of a microresonator system;

FIG. 4 is a schematic top-view of a microresonator system;

FIG. 5 is a schematic three-dimensional view of an optical waveguide;

FIG. 6 is a schematic top-view of a microresonator system;

FIG. 7 is a schematic top-view of an optical waveguide system;

FIG. 8 is a schematic top-view of an optical waveguide system;

FIG. 9 is a schematic top-view of a microresonator system;

FIG. 10 is a schematic top-view of a microresonator system;

FIG. 11 is a schematic top-view of a microresonator system;

FIG. 12 is a schematic top-view of a microresonator system;

FIG. 13 is a schematic top-view of a microresonator system;

FIG. 14 is a schematic three-dimensional view of an integrated optical device;

FIG. 15 is a schematic three-dimensional view of a microresonator system;

FIG. 16 is a plot of calculated signal strength versus wavelength for various microresonator systems;

FIG. 17 is a schematic top-view of an optical device;

FIG. 18 is a plot of calculated signal strength versus wavelength for a microresonator system without a scattering center;

FIG. 19 is a schematic top-view of a microresonator system; and

FIG. 20 is a schematic top-view of a microresonator system.

In the specification, a same reference numeral used in multiple figures refers to the same or similar elements having the same or similar properties and functionalities.

### DETAILED DESCRIPTION

This invention generally relates to microresonator systems. The invention is particularly applicable to microresonator systems that incorporate optical microcavities.

The present application discloses microresonator systems that include an optical microresonator optically coupled, such as core coupled, to an optical waveguide and an optical microcavity. The optical microcavity can be designed to support primarily one or more resonant modes. The microresonator is capable of supporting optical guided modes such as optical resonant modes. The coupling of the resonant modes of the microcavity to the resonant modes of the microresonator leads to formation of resonant modes of the microresonator system. A microresonator system resonant mode can generally correspond to high storage of an electric field in the system. In some cases, such as when an output port of the system is located in a suitable position, the high field storage can result in high system optical transmission and narrow bandwidth making the microresonator suitable for applications such as wavelength filtering and chemical and biological sensing.

As used herein, for a given optical configuration such as a microresonator system disclosed in the present application, an optical mode refers to an allowed electromagnetic field in the optical configuration; radiation or radiation mode refers to an optical mode that is unconfined in the optical configuration; and a guided mode refers to an optical mode that is confined in the optical configuration in at least one dimension due to the presence of a high index region, where the high index region is typically a core region. A guided mode that is confined in one dimension (first dimension) may be referred to as a one-dimensional guided mode and a guided mode that is confined in two mutually orthogonal dimensions (first and second dimensions) may be referred to as a two-dimensional guided mode.

A resonant mode refers to an optical mode that is confined in three mutually orthogonal dimensions (first, second, and third dimensions). A resonant mode may be considered a three-dimensional guided mode or a two-dimensional guided mode that is subject to an additional boundary condition requirement along a third dimension in the optical configuration, where the additional requirement is typically periodic in nature.

A resonant mode is a discrete mode resulting from a quantization of an optical mode in the optical configuration along three mutually orthogonal dimensions. In general, exciting or energizing an optical configuration at a frequency or wavelength corresponding to a resonant mode of the optical configuration results in a substantially stronger stored electromagnetic field and, in some cases, a substantially stronger response, such as high optical throughput, by the optical configuration compared to a response resulting from an off-resonance excitation.

The mode profile of a resonant mode of an optical configuration can be determined by boundary conditions along three mutually orthogonal dimensions. In some cases, a resonant mode can be a traveling-wave mode or primarily a traveling-wave mode. In some other cases, a resonant mode can be a standing-wave mode or primarily a standing-wave mode. In some cases, a resonant mode can be part standing-wave and part traveling-wave.

In some cases, an optical mode can be primarily a resonant mode. In such cases, the optical mode can have a non-resonant component, such as a non-resonant traveling-wave component. In such cases, however, the non-resonant component is secondary to the resonant component of the optical mode. For example, the non-resonant component can be a small portion of the overall optical mode intensity.

In some cases, a resonant mode can be capable of coupling to a radiation mode. In some other cases, an optical mode can have a primary component that is resonant and a secondary component that is radiation and not confined. In general, a guided mode, such as a two-dimensional guided mode, can be a resonant mode or a non-resonant mode.

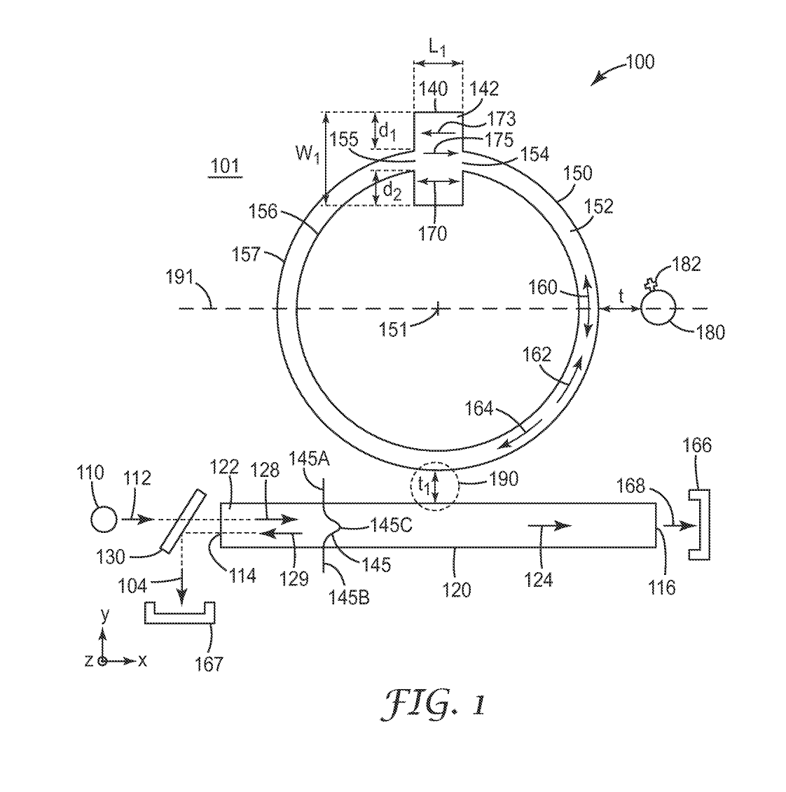

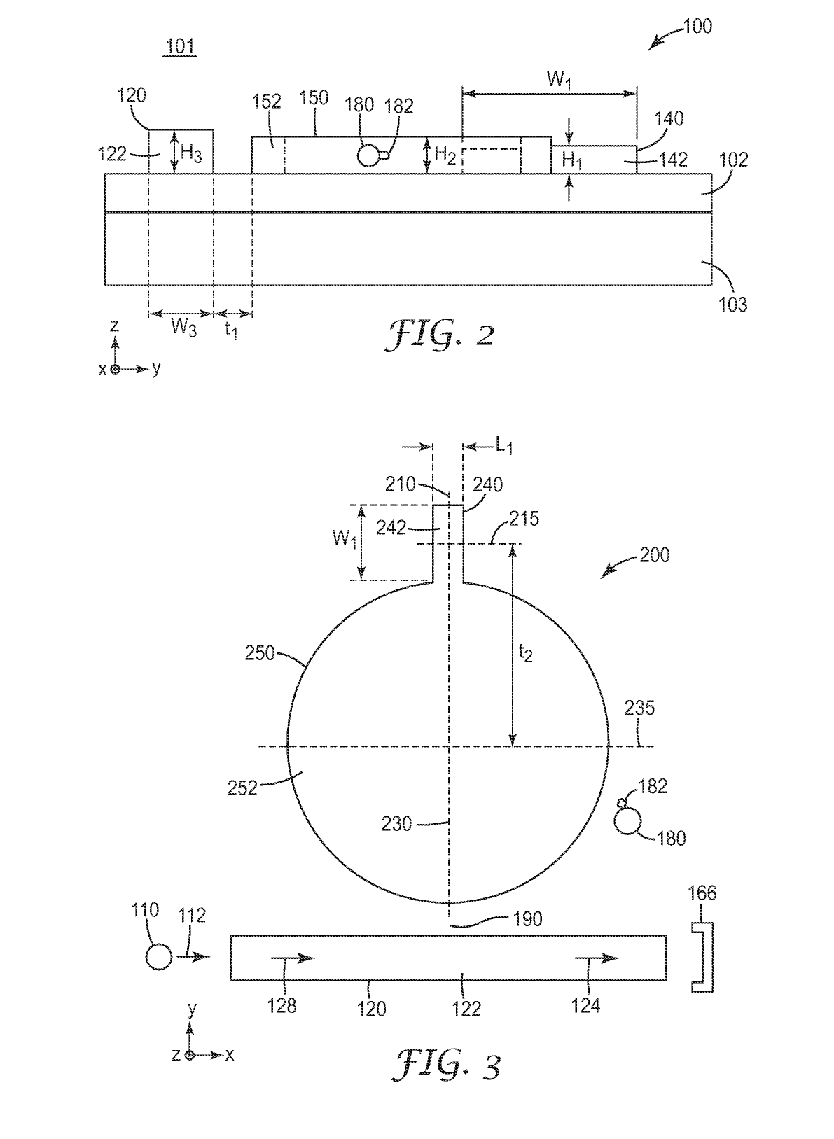

FIGS. 1 and 2 show schematic top- and side-views of a microresonator system 100, respectively. The microresonator system includes an optical waveguide 120, an optical microresonator 150, and an optical microcavity 140 that is core coupled to optical microresonator 150 but not to optical waveguide 120. Optical microresonator 150 is directly optically coupled to optical waveguide 120. As used herein, an optical coupling between two modes is direct when the coupling occurs primarily because of at least a partial overlap between the two corresponding electromagnetic fields. In cases where an optical coupling occurs between two modes where there is no or very little overlap between the corresponding fields, the coupling is considered to be indirect. For example, a mode of waveguide 120 can directly couple to a mode of microresonator 150. As another example, a mode of waveguide 120 can indirectly, that is through microresonator 150, couple to a mode of microcavity 140. A direct optical coupling can be a core coupling or an evanescent coupling or a combination of core and evanescent couplings as described elsewhere in this application.

Optical waveguide 120 includes an upper cladding 101, a lower cladding 102 disposed on a substrate 103, and an optical core 122 which has a width W₃, a height or thickness H₃, an input face 114 and an output face 116. Optical waveguide 120 is capable of supporting one or more optical guided modes, such as guided modes 128 and 124 traveling along the positive x-axis and a guided mode 129 traveling along the negative x-axis. In some cases, one or more of guided modes 124, 128, and 129 can be a single transverse guided mode.

Optical microresonator 150 includes upper cladding 101, lower cladding 102, and an optical core 152 which has a height or thickness H₂ and is optically coupled to optical waveguide 120 by an evanescent coupling in a coupling region 190. Optical core 152 is separated from optical core 122 by a distance t₁. In general, optical microresonator 150 is capable of supporting resonant and non-resonant modes. In some cases, a resonant mode 160 of the microresonator is primarily a standing-wave. In such cases, mode 160 can have a traveling-wave component, but any such component is secondary to the primary standing-wave component or nature of the resonant mode. In some cases, resonant standing-wave mode 160 can be equivalent to an interferometric superposition of two or more traveling-waves, such as respective first and second traveling-waves 162 and 164, traveling in generally different such as opposite directions within microresonator 150. In some cases, such as in the case of a ring-shaped microresonator 150 shown in FIG. 1, traveling-wave modes 162 and 164 can be counter propagating guided modes of the microresonator. Standing-wave mode 160 and traveling-wave modes 162 and 164 have the same frequency and/or free space wavelength.

In some cases, resonant mode 160 of the microresonator is primarily a traveling-wave traveling, for example, counter clockwise inside microresonator 150. In such cases, mode 160 can have a standing-wave component, but any such component is secondary to the primary traveling-wave component or nature of the resonant mode.

The exemplary optical microresonator 150 shown in FIG. 1 is a ring microresonator. In general, microresonator 150 can be any optical microresonator capable of optically coupling to waveguide 120 and microcavity 140.

In some cases, microresonator 150 can have a circular symmetry, meaning that the perimeter of a cross-section of core 152 in the xy-plane can be expressed as a function of distance from a central point only. In some cases, such as in a circular ring microresonator 150 shown schematically in FIG. 1, the central point can be a center 151 of core 152 of the microresonator. Other exemplary microresonators having circular symmetry include a sphere, a disk, and a cylinder. For example, FIG. 3 shows a schematic top-view of a microresonator system 200 that includes a disk microresonator 250 having a core 252 that is optically coupled to optical waveguide 120, and an optical microcavity 240 having a core 242 that is optically coupled to disk microresonator 250.

Optical microcavity 240 is capable of supporting primarily one or more resonant modes, where, in general, a supported resonant mode can be primarily a resonant standing-wave, a resonant traveling-wave, or a resonant mode that has substantial traveling- and standing-wave components.

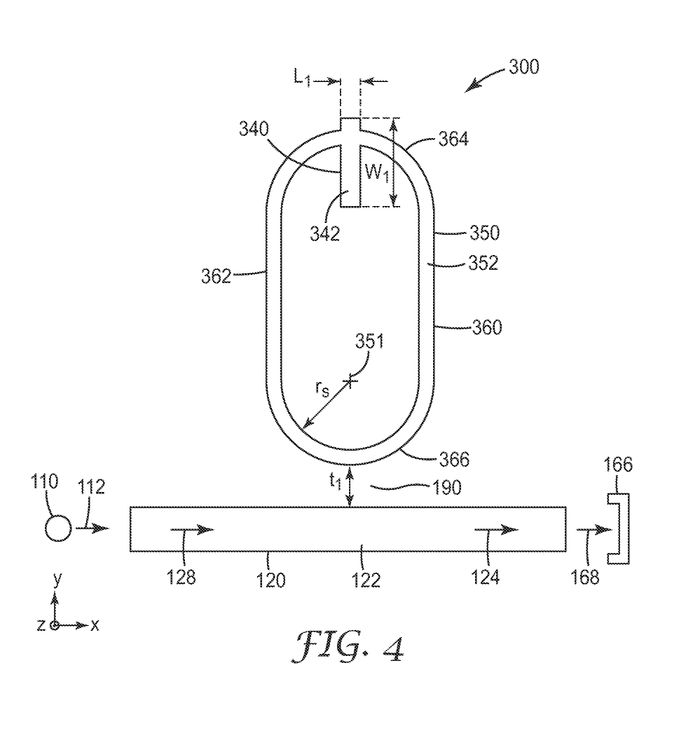

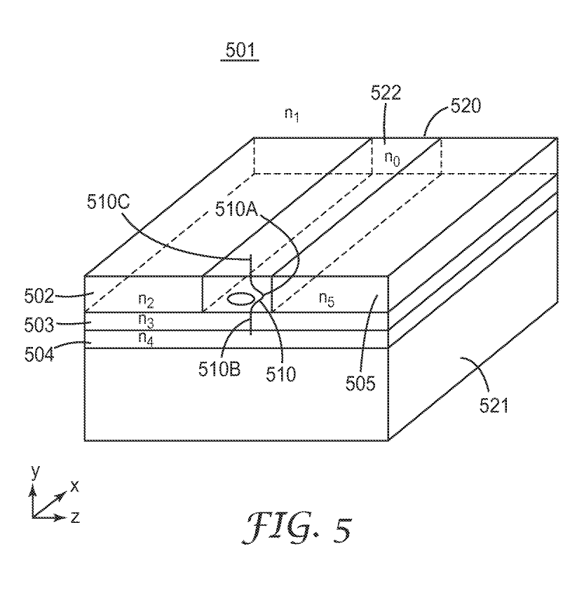

In some cases, microresonator 150 can have a spherical symmetry such as in the case of a sphere-shaped microresonator. In some cases, microresonator 150 can be a closed loop microresonator such as a ring or a racetrack microresonator. For example, FIG. 4 shows a schematic top-view of a microresonator system 300 that includes a racetrack microresonator 350 having a core 352 that is optically coupled to optical waveguide 120 in coupling region 190, and an optical microcavity 340 having a core 342 that is optically coupled to racetrack microresonator 350. Optical microcavity 340 is capable of supporting primarily one or more resonant modes, such as one or more resonant standing-wave modes. Core 352 of microresonator 350 has linear portions 360 and 362, and curved portions 364 and 366. In the exemplary racetrack shown in FIG. 4, curved portions 364 and 366 are semi-circles. In particular, semi-circle curved portion 366 has a center 351 and an inside radius rₛ. In general, curved portions 364 and 366 can be any type of curved portions connecting linear portions 360 and 362.

In general, microresonator 150 may be single or multimode along a particular direction. For example, microresonator 150 can be single mode or multimode along the height or thickness direction (the z-axis) of the microresonator. In some cases, such as in the case of a ring-shaped microresonator, the microresonator can be single or multimode along a radial direction. In some cases, such as in the case of a ring-shaped microresonator, traveling-wave guided modes 162 and 164 of microresonator 150 can be azimuthal modes of the microresonator.

Optical microcavity 140 includes upper cladding 101, lower cladding 102, and an optical core 142 having a height or thickness H₁. Microcavity 140 is capable of supporting primarily one or more resonant modes where, in some cases, a resonant mode of the microcavity can be primarily a traveling-wave, and in some other cases, a resonant mode of the microcavity can be primarily a standing-wave. In some cases, a resonant mode of the microcavity can have substantial traveling- and standing-wave components.

Microcavity 140 is capable of supporting primarily one or more resonant modes where each resonant mode can be, for example, a traveling-wave, a standing-wave, or a combination of the two. In some cases, microcavity 140 may be capable of supporting a non-resonant mode such as a non-resonant traveling-wave, but such a non-resonant mode is secondary to the resonant modes supported by the microcavity.

In some cases, a resonant mode of microcavity 140 can be primarily a standing-wave mode where, in general, the standing-wave can be equivalent to an interferometric superposition of two traveling-waves traveling in generally different such as opposite directions. In such cases, the resonant mode supported by microcavity 140 can have a resonant traveling portion, but any such traveling portion forms a small fraction of the overall resonant mode, meaning that the resonant mode is primarily standing-wave in nature and any resonant traveling portion of the mode is only secondary to the standing-wave portion of the mode.

In some cases, a resonant mode of microcavity 140 can be primarily a traveling-wave mode. In such cases, the resonant mode supported by microcavity 140 may have a resonant standing-wave portion, but any such standing-wave portion forms a small fraction of the overall resonant mode, meaning that the resonant mode is primarily traveling in nature and any resonant standing-wave portion of the mode is only secondary to the traveling portion of the mode.

A resonant mode of microcavity 140 can be primarily standing-wave in nature when, for example, the microcavity has a large reflection along a boundary of core 142 resulting in a large percentage of an incident wave being reflected. In such cases, the reflected wave interferes with the incident wave to form a wave that is predominantly standing-wave in nature. Any traveling-wave component of the resonant mode is secondary to the standing-wave portion of the resonant mode.

A resonant mode of microcavity 140 can be primarily traveling in nature when, for example, the microcavity has small reflections along the boundary of core 142 resulting in only a small percentage of an incident wave being reflected. In such cases, the reflected and incident waves interfere to form a wave that is predominantly traveling-wave in nature. Any standing-wave component of the resonant mode is secondary to the traveling-wave portion of the resonant mode.

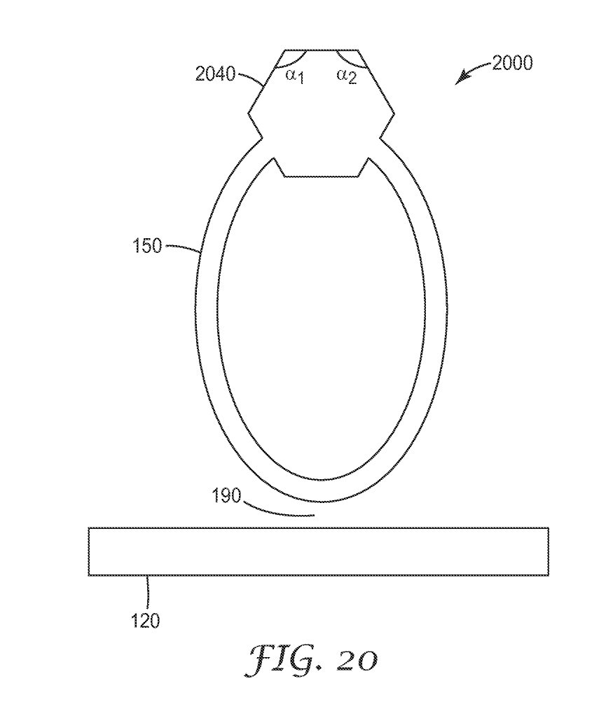

In the exemplary microresonator system 100 shown in FIGS. 1 and 2, optical microcavity core 142 is a rectangular solid having a length L₁ along the x-axis, a width W₁ along the y-axis, and a height H₁ along the z-axis. In general, microcavity 140 can include any shape microcavity core 142 capable of supporting primarily one or more resonant modes. Exemplary shapes for optical microcavity core 142 include a sphere, a disk, a cylinder, a ring, a toroid, or a racetrack. In some cases, microcavity core 142 can be a regular or an irregular polygon. In some cases, microcavity core 142 can be a closed loop microcavity core. For example, FIG. 20 shows a schematic top-view of an optical microresonator system that includes a hexagonal optical microcavity 2040 core coupled to microresonator 150. In some cases, hexagonal microcavity 2040 is a regular hexagon, in which case, each of the six internal angles, such as angles α₁ and α₂, is 120°, and the hexagon has 6 lines of symmetry. In some cases, hexagonal microcavity 2040 is an irregular hexagon.

In the exemplary microresonator system 100 shown in FIGS. 1 and 2, waveguide 120, microresonator 150, and microcavity 140 have the same upper cladding 101 and the same lower cladding 102. In general, different waveguiding elements in microresonator system 100 can have different upper and/or lower and/or side claddings. For example, waveguide 120 and microresonator 150 can have different upper claddings.

In general, a waveguiding element, such as optical waveguide 120, in microresonator system 100 can have different and/or multiple claddings along different directions. For example, FIG. 5 shows an optical waveguide 520 disposed on a substrate 521 that includes an optical core 522 having a refractive index nₒ, an upper cladding 501 having a refractive index n₁, a left side cladding 502 having a refractive index n₂, a first lower cladding 503 having a refractive index n₃, a second lower cladding 504 having a refractive index n₄, and a right side cladding 505 having a refractive index n₅. In some cases, the core index nₒ is larger than the refractive indices of some or all of the claddings surrounding the core. A guided mode 510 of optical waveguide 520 propagating along, for example the x-direction, can have a peak field intensity 510A within core 522, an evanescent tail 510B within lower claddings 503 and 504, and an evanescent tail 510C within upper cladding 501. Optical waveguide 520 can, for example, be optical waveguide 120 of microresonator system 100.

In the exemplary microresonator system 100 shown in FIGS. 1 and 2, microcavity core 142 extends equally beyond an inner perimeter 156 of core 152 and an outer perimeter 157 of core 152. In particular, distances d₁ and d₂ are equal. In general, microcavity core 142 can be positioned in any location and/or with any orientation that provides optical coupling between microcavity 140 and microresonator 150 in an application.

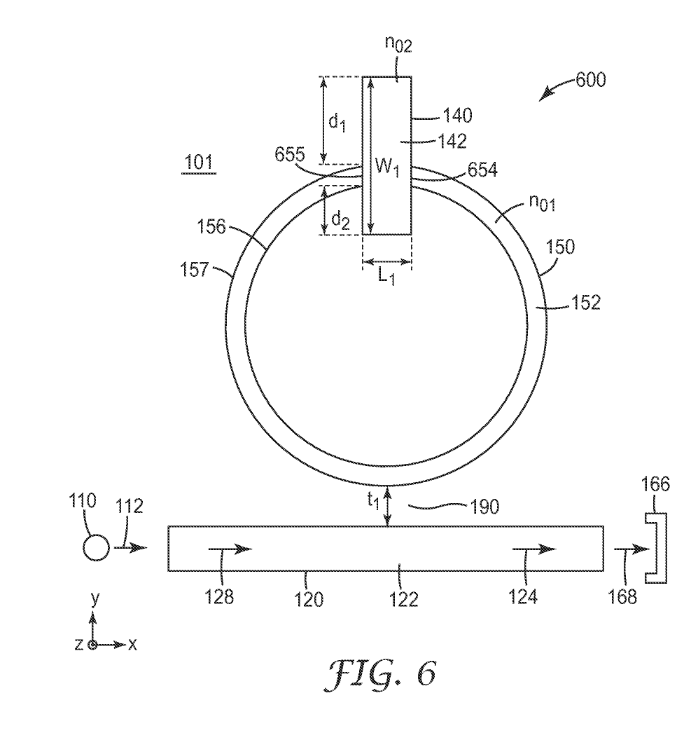

For example, FIG. 6 shows a schematic top-view of a microresonator system 600 in which microcavity core 142 extends unequally beyond inner perimeter 156 and outer perimeter 157, meaning that distances d₁ and d₂ are not equal. In the exemplary microresonator system 600, distance d₁ is greater than distance d₂.

In the exemplary microresonator system 100, core 152 of optical microresonator 150 extends from core 142 of optical microcavity 140 at first face 154 and second face 155. Cores 142 and 152 form a unitary construction, meaning that the cores form a single unit with no physical interfaces between the connecting cores. In a unitary construction, the cores are typically made of the same core material. A unitary construction can be made using a variety of known methods such as etching, casting, molding, embossing, and extrusion.

In general, cores 142 and 152 may or may not form a unitary construction. In some cases, cores 142 and 152 may be made of different materials having the same refractive index. In some cases, cores 142 and 152 may be made of different materials having different refractive indices. For example, in microresonator system 600 of FIG. 6, core 152 has a refractive index nₒ₁ and core 142 has a refractive index nₒ₂ that is different than nₒ₁. Cores 152 and 142 do not form a unitary construction as the index difference between the two cores results in the formation of respective first and second interfaces 654 and 655 between the two cores.

In the exemplary microresonator system 600, the optical coupling between microcavity 140 and microresonator 150 is at least primarily an optical core coupling and the optical coupling between microresonator 150 and optical waveguide 120 is an evanescent coupling.

In general, an optical waveguide has a core or a core region that is surrounded by a cladding or cladding region. Each of the core and cladding may include one or more materials. Typically, for an optical mode confined in the optical waveguide, such as an optical guided mode of the waveguide, the index of the cladding is less than the index of the core. The confined optical mode typically has a core field component and an evanescent field component. The core field typically exits within the core and includes one or more peaks. The evanescent field is typically a decaying field that exists within the cladding. The evanescent field is sometimes referred to as the evanescent tail of the confined optical mode.

In general, optical energy can transfer from a first mode in a first optical waveguide to a second mode in a second optical waveguide placed near the first optical waveguide by different methods. For example, the optical energy can transfer from the first mode to the second mode by core coupling. As another example, the transfer of optical energy between the two modes can be by evanescent coupling. As another example, some of the optical energy can transfer by core coupling and some of the optical energy can transfer by evanescent coupling.

Evanescent coupling between two modes typically refers to a transfer of optical energy primarily due to an overlap of the evanescent fields of the two modes. In some cases, some energy may be transferred by means other than evanescent coupling, such as by core coupling, but any such energy transfer is secondary to energy transfer due to evanescent coupling.

Core coupling between two modes typically refers to a transfer of optical energy primarily due to an overlap of the core fields of the two modes. In some cases, some energy may be transferred by means other than core coupling, such as by evanescent coupling, but any such energy transfer is secondary to energy transfer due to core coupling.

In some cases, such as when there is an overlap between the core fields of the two modes as well as between the evanescent fields of the two modes, optical coupling between the two modes can have substantial core and evanescent coupling portions.

Coupling region generally refers to a region where optical energy can be transferred between a first and a second optical waveguides. In some cases, a portion of the coupling region can include a region of overlap between the core fields of the two modes and another portion of the coupling region can include a region of overlap between the evanescent fields of the two modes.

In some cases, a coupling region includes regions of overlap where each mode has sufficiently high field intensity. In some cases, coupling region is a region where the transferred energy is at least 20% of the transferable energy, or at least 30% of the transferable energy, or at least 40% of the transferable energy, or at least 50% of the transferable energy, or at least 60% of the transferable energy, or at least 70% of the transferable energy, or at least 80% of the transferable energy, or at least 90% of the transferable energy, or at least 95% of the transferable energy.

In some cases, a coupling region is a region where the transferred energy is no more than 10% of the transferable energy, or no more than 7% of the transferable energy, or no more than 5% of the transferable energy, or no more than 3% of the transferable energy, or no more than 2% of the transferable energy, or no more than 1% of the transferable energy, or no more than 0.5% of the transferable energy.

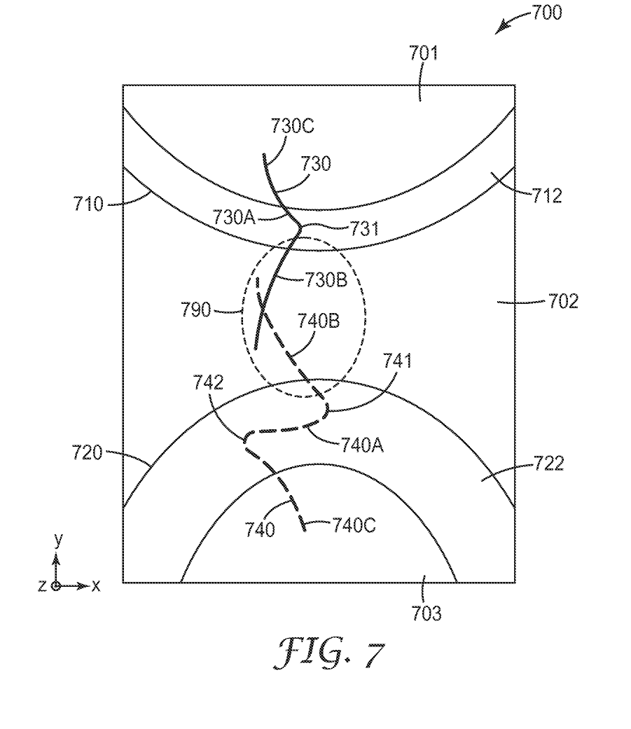

FIG. 7 shows a schematic top-view of an optical waveguide system 700 that includes closely spaced first optical waveguide 710 and second optical waveguide 720. First optical waveguide 710 includes a core 712 disposed between claddings 701 and 702 and is capable of supporting a first guided mode 730 that includes a core field 730A inside core 712, an evanescent field 730B in cladding 702, and an evanescent field 730C in cladding 701. Core field 730A has a peak 731 within core 712.

Second optical waveguide 720 includes a core 722 disposed between cladding 702 and a cladding 703 and is capable of supporting a second guided mode 740 that includes a core field 740A inside core 722, an evanescent field 740B in cladding 702, and an evanescent field 740C in cladding 703. Core field 740A has peaks 741 and 742 within core 722.

The overlap between evanescent fields 730B and 740B can lead to a transfer of optical energy between first optical waveguide 710 and second optical waveguide 720. For example, first guided mode 730 launched in waveguide 710 can evanescently couple to waveguide 720 resulting in an excitation of second guided mode 740 in waveguide 720. Region 790 schematically represents the coupling region between the two waveguides for modes 730 and 740.

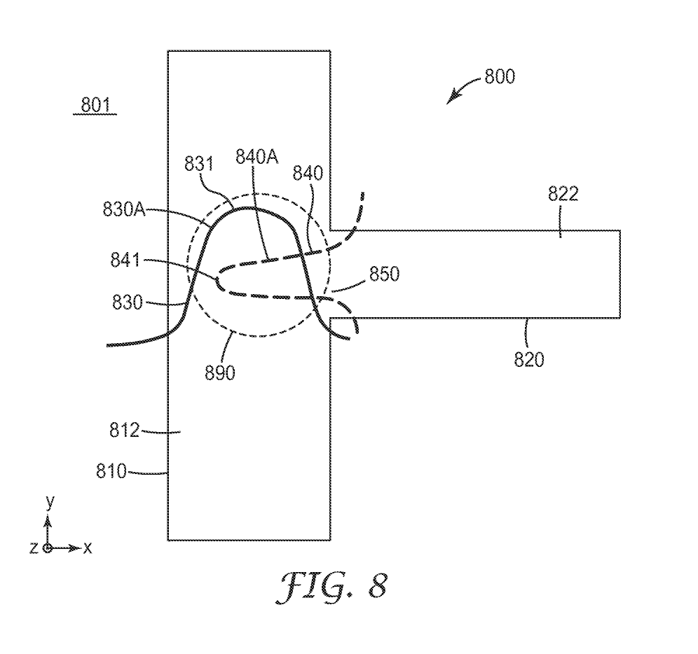

FIG. 8 shows a schematic top-view of an optical waveguide system 800 that includes first optical waveguide 810 having a core 812 and a second optical waveguide 820 having a core 822. Cores 812 and 822 intersect or join at an intersect area 850. In some cases, cores 812 and 822 can form a unitary construction. In such cases, core 822 can be considered to extend from core 812, or core 812 can be considered to extend from core 822.

Cores 812 and 822 are surrounded by cladding 801. First optical waveguide 810 is capable of supporting a first guided mode 830 that includes a core field 830A inside core 812. Core field 830A has a peak 831 within core 812. Second optical waveguide 820 is capable of supporting a second guided mode 840 that includes a core field 840A inside core 822. Core field 840A has a peak 841 within core 822.

The overlap between core fields 830A and 840A can lead to a transfer of optical energy between first optical waveguide 810 and second optical waveguide 820. For example, guided mode 840 launched in waveguide 820 can core couple to waveguide 810 resulting in an excitation of guided mode 830 in waveguide 810. Region 890 schematically represents the coupling region between the two waveguides for modes 830 and 840.

Optical coupling between two waveguides at a location is typically a core coupling when, for example, the cores of the two waveguides are attached, connected, or joined at the location. For example, in microresonator system 100, core 152 of microresonator 150 is joined with core 142 of microcavity 140 at first and second faces 154 and 155, respectively. Microresonator 150 optically couples to microcavity 140 primarily by core coupling at/or near faces 154 and 155 and/or in regions that include the respective faces. The coupling region at face 154 includes face 154 and regions near to and surrounding face 154. Similarly, the coupling region at face 155 includes face 155 and regions near to and surrounding face 155.

In the case of evanescent coupling between two waveguides at a location, the two cores are typically spaced apart at the location with one or more claddings occupying the gap between the cores of the two waveguides. For example, optical coupling between waveguide 120 and microresonator 150 is primarily an evanescent coupling. Cladding 101 occupies the gap between cores 122 and 152 at coupling region 190.

In general, in the disclosed embodiments, a microresonator core and a microcavity core may or may not have parallel axes of symmetry. For example, in microresonator system 200 of FIG. 3, microcavity core 242 has an axis of symmetry 210 along the y-axis that is generally directed at, for example passes through, coupling region 190 and an axis of symmetry 215 along the x-axis orthogonal to axis of symmetry 210. Axis of symmetry 210 is along the width direction of the microcavity and axis of symmetry 215 is along the length direction of the microcavity. The microcavity has a length L₁ along the length direction of the microcavity and a width W₁ along the width direction of the microcavity. Microresonator core 252 has many axes of symmetry including an axis of symmetry 230 along the y-axis and an axis of symmetry 235 along the x-axis orthogonal to axis of symmetry 230. Axis of symmetry 230 is coincident or collinear with axis of symmetry 210. Accordingly, microcavity core 242 and microresonator core 252 share the same axis of symmetry along the y-axis, where the shared axis of symmetry is along the width direction of the microcavity. Axes of symmetry 215 and 235 are not collinear. In particular, the two axes are offset laterally from one another a distance t₂ along the y-direction.

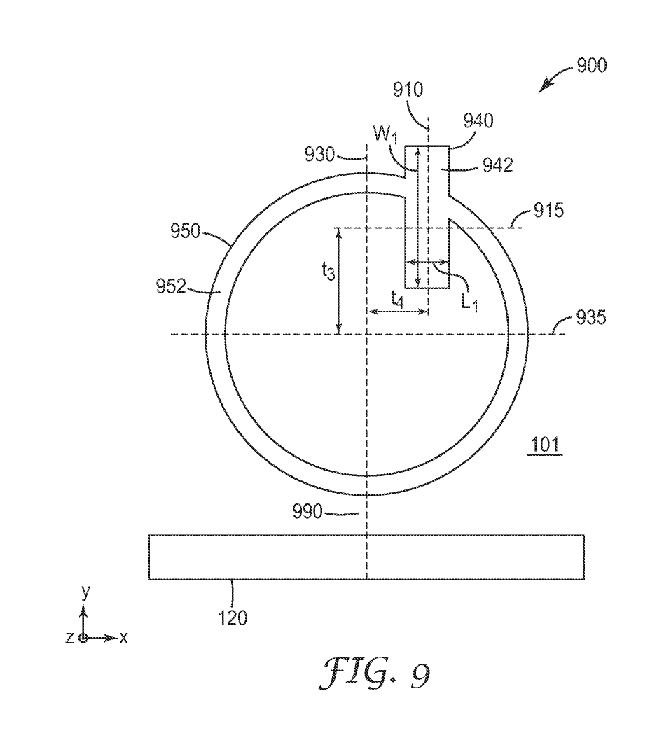

FIG. 9 shows a schematic top-view of a microresonator system 900 that includes optical waveguide 120, an optical microresonator 950 having a core 952 that is optically coupled to waveguide 120 in coupling region 990, and an optical microcavity 940 having a core 942 that is optically coupled to microresonator 950 but not to waveguide 120. A guided mode supported by optical waveguide 120 can directly excite a mode such as a first resonant mode of optical microresonator 950, meaning that, for example, an evanescent tail of the guided mode at least partially overlaps an evanescent tail of the first resonant mode. Optical microcavity 940 is capable of supporting one or more modes, such as one or more resonant modes, such as a second resonant mode. The second resonant mode can be directly excited by the first resonant mode, meaning that, for example, an evanescent tail of the first resonant mode at least partially overlaps an evanescent tail of the second resonant mode. The second resonant mode, however, is not capable of being excited directly by the guided mode because there is no overlap between the core fields and/or the tails of the two modes. Rather, the second resonant mode is indirectly excited by the guided mode, meaning that the guided mode excites the second resonant mode by first directly exciting the first resonant mode.

Microresonator core 952 has an axis of symmetry 930 along the y-axis that is generally directed at coupling region 990, and an axis of symmetry 935 along the x-axis that is orthogonal to axis of symmetry 930. Microcavity core 942 has an axis of symmetry 910 along the y-axis that is parallel to but not collinear with axis 930, and an axis of symmetry 915 along the x-axis that is parallel to but not collinear with axis 935.

Accordingly, microresonator core 952 and microcavity core 942 do not have collinear axes of symmetry or share a common axis of symmetry. In particular, axis 910 is offset laterally from axis 930 a distance t₄ and axis 915 is offset laterally from axis 935 a distance t₃.

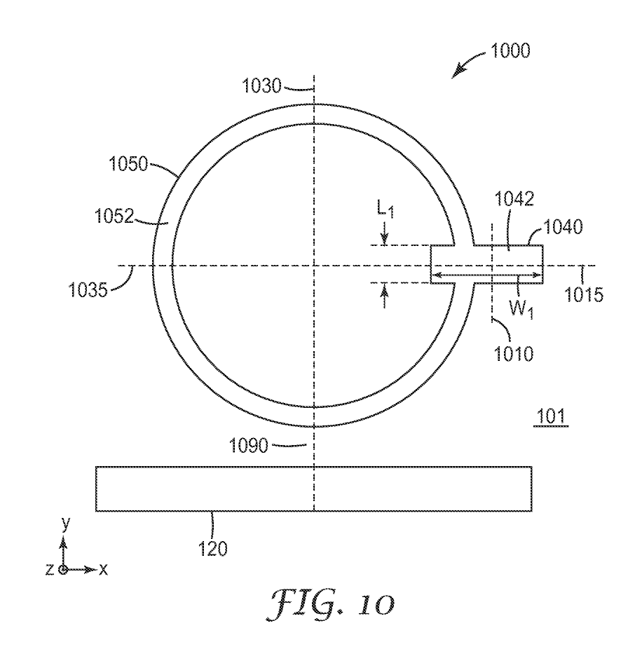

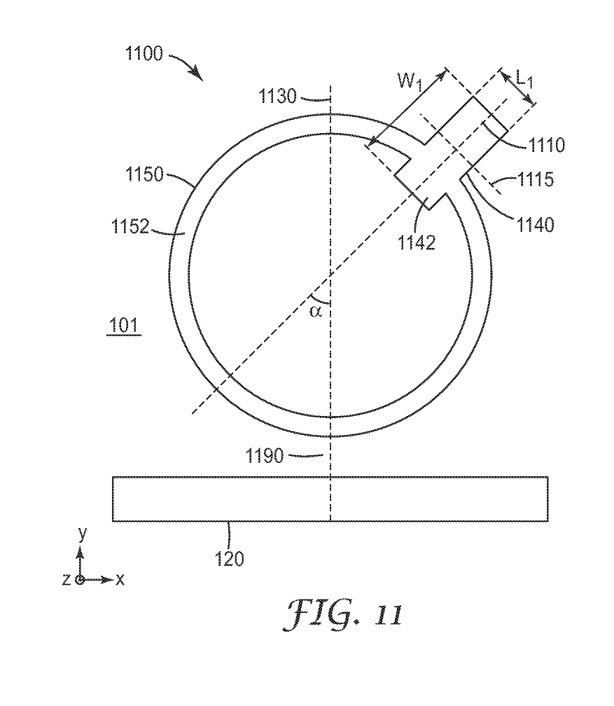

FIG. 10 shows a schematic top-view of a microresonator system 1000 that includes optical waveguide 120, an optical microresonator 1050 having a core 1052 that is optically coupled to waveguide 120 in coupling region 1090, and an optical microcavity 1040 having a core 1042 that is optically coupled to microresonator 1050 but not to waveguide 120.

Microresonator core 1052 has an axis of symmetry 1030 along the y-axis that is generally directed at coupling region 1090, and an axis of symmetry 1035 along the x-axis that is orthogonal to axis of symmetry 1030. Microcavity core 1042 has an axis of symmetry 1010 along the y-axis that is parallel to but not collinear with axis 1030, and an axis of symmetry 1015 along the x-axis that is collinear with axis 1035.

Microresonator core 1052 and microcavity core 1042 share an axis of symmetry that is along the width direction of the microcavity, but is not directed at coupling region 1090. Accordingly, microresonator core 1052 and microcavity core 1042 do not have collinear axes of symmetry, or share a common axis of symmetry, that is generally directed at coupling region 1090.

FIG. 11 shows a schematic top-view of a microresonator system 1100 that includes optical waveguide 120, an optical microresonator 1150 having a core 1152 that is optically coupled to waveguide 120 in coupling region 1190, and an optical microcavity 1140 having a core 1142 that is optically coupled to microresonator 1150 but not to waveguide 120.

Microresonator core 1152 has an axis of symmetry 1130 along the y-axis that is generally directed at coupling region 1190. Microcavity core 1142 has an axis of symmetry 1110 along the width direction of the microcavity and an axis of symmetry 1115 along the length direction of the microcavity. Axis of symmetry 1110 of the microcavity is also an axis of symmetry for microresonator core 1152.

Microresonator core 1152 and microcavity core 1142 share an axis of symmetry 1110 that is along the width direction of the microcavity, but is not directed at coupling region 1190. Accordingly, microresonator core 1152 and microcavity core 1142 do not have collinear axes of symmetry, or share a common axis of symmetry, that is generally directed at coupling region 1190.

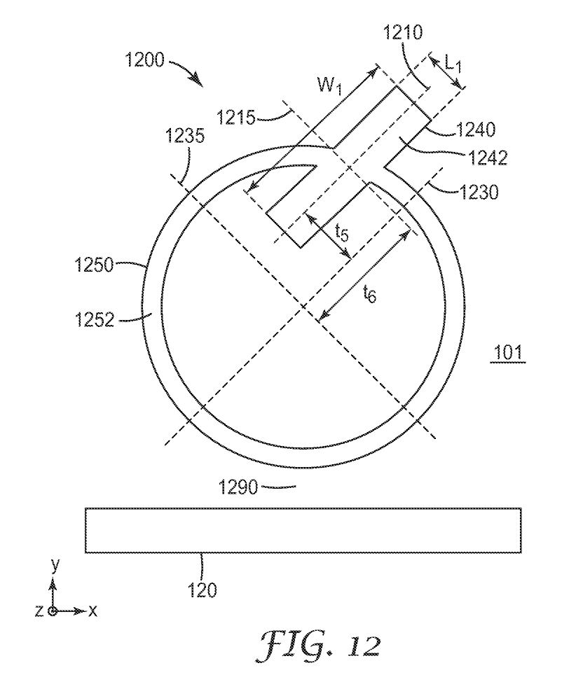

FIG. 12 shows a schematic top-view of a microresonator system 1200 that includes optical waveguide 120, an optical microresonator 1250 having a core 1252 that is optically coupled to waveguide 120 in coupling region 1290, and an optical microcavity 1240 having a core 1242 that is optically coupled to microresonator 1250 but not to waveguide 120.

Microcavity core 1242 has an axis of symmetry 1210 along the width direction of the microcavity and an axis of symmetry 1215 along the length dimension of the microcavity. Microresonator core 1252 has an axis of symmetry 1230 that is parallel to but not collinear with axis 1210, and an axis of symmetry 1235 that is parallel to but not collinear with axis 1215.

Microresonator core 1252 and microcavity core 1242 share an axis of symmetry that is along the width direction of the microcavity, but is not generally directed at coupling region 1290. Accordingly, microresonator core 1252 and microcavity core 1242 do not have collinear axes of symmetry, or share a common axis of symmetry, that is generally directed at coupling region 1290. Axis 1210 is offset laterally from axis 1230 a distance t₅ and axis 1215 is offset laterally from axis 1235 a distance t₆.

The exemplary microresonator system 100 of FIG. 1 includes a single optical microcavity. In general, a microresonator system can include one or more optical microcavities where at least one of the microcavities is capable of supporting primarily one or more resonant modes.

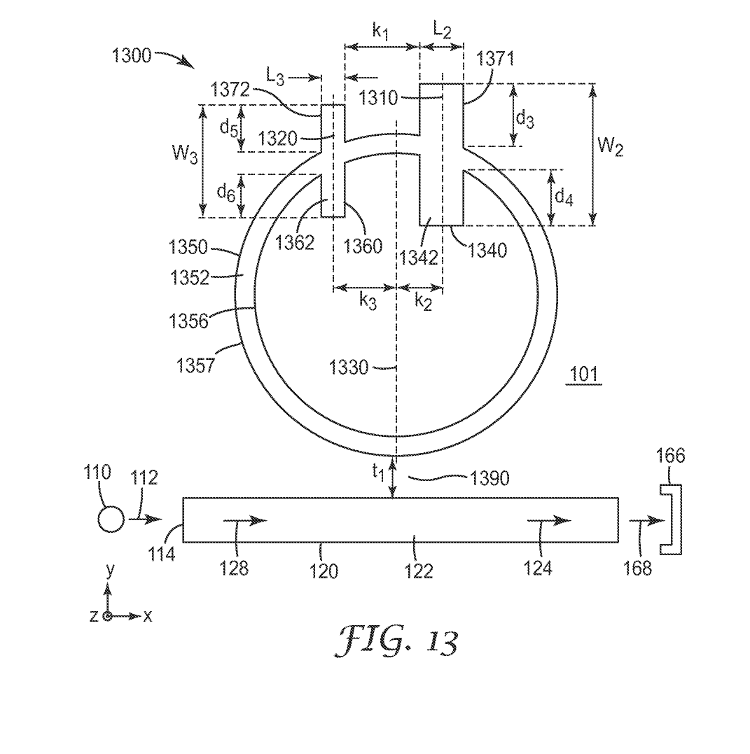

For example, FIG. 13 shows a schematic top-view of a microresonator system 1300 that includes optical waveguide 120, an optical microresonator 1350 having a core 1352 that is optically coupled to waveguide 120 in coupling region 1390, a first optical microcavity 1340 having a core 1342 that is optically coupled to microresonator 1350 but not to waveguide 120, and a second optical microcavity 1360 having a core 1362 that is optically coupled to microresonator 1350 but not to waveguide 120. In some cases, at least one of microcavities 1340 and 1360 is capable of supporting primarily one or more resonant modes.

Optical microresonator 1350 is optically coupled to microcavity 1340 along the width dimension of microcavity 1340 along the y-axis. Microcavity core 1342 has a width W₂ and a length L₂. In the exemplary microresonator system 1300, microcavity core 1342 extends equally beyond an inner perimeter 1356 and an outer perimeter 1357 of core 1352 along at least one width side, such as width side 1371, of the microcavity. In particular, distances d₃ and d₄ are equal. In general, microcavity core 1342 can be positioned in any location and/or with any orientation that provides optical coupling between microcavity 1340 and microresonator 1350 in an application.

Optical microresonator 1350 is optically coupled to microcavity 1360 along the width dimension of microcavity 1360 along the y-axis. Microcavity core 1362 has a width W₃ and a length L₃. In the exemplary microresonator system 1300, microcavity core 1362 extends equally beyond inner perimeter 1356 and outer perimeter 1357 along at least one width side, such as width side 1372. In particular, distances d₅ and d₆ are equal. In general, microcavity core 1362 can be positioned in any location and/or with any orientation that provides optical coupling between microcavity 1360 and microresonator 1350 in an application.

In the exemplary microresonator system 1300, microcavities 1340 and 1360 are not directly optically coupled to one another. For example, the separation k₁ between cores 1342 and 1362 is sufficiently large that there is no or very little evanescent coupling between the two microcavities. In some cases, distance k₁ can be sufficiently small to allow an optical coupling between the two microcavities.

In some cases, each of the two microcavities is capable of supporting primarily one or more resonant modes. In such cases, the optical coupling of the resonant modes of the two microcavities to the resonant modes of the microresonator can lead to the formation of resonant modes of the microresonator system 1300. In some cases, system resonant modes can exist when, for example, one or more resonant modes of each microcavity and the microresonator are sufficiently close to one another, such as, for example, when in microresonator system 100 distance t₁ is about 100-10,000 nanometers.

Microresonator core 1352 has an axis of symmetry 1330 along the y-axis that is directed at coupling region 1390. Microcavity core 1342 has an axis of symmetry 1310 that is parallel to axis 1330 and is offset laterally from axis 1330 a distance k₂. Microcavity core 1362 has an axis of symmetry 1320 that is parallel to axis 1330 and is offset laterally from axis 1330 a distance k₃.

Referring back to FIG. 1, light source 110 is capable of emitting light beam 112, at least a portion of which enters optical waveguide 120 through input face 114. In some cases, light entering optical waveguide 120 from light source 110 can propagate along the waveguide as a guided mode of the waveguide, such as guided mode 128. In some cases, guided mode 128 excites a resonant mode 160 of optical microresonator 150. In some cases, resonant mode 160 excites a resonant mode 170 of optical microcavity 140. In some cases, resonant modes 170 and 160 can be standing-wave modes of microcavity 140 and microresonator 150, respectively. In general, the optical coupling between resonant modes 170 and 160 can form a resonant mode of microresonator system 100.

In some cases, resonant mode 160 of microresonator 150 can excite guided mode 124 of optical waveguide 120 traveling along the positive x-axis towards detector 166. Guided mode 124 can exit the optical waveguide from output face 116 as an output light 168. Output light 168 can be detected by detector 166. In general, detector 166 is capable of detecting one or more characteristics of a mode, such as a resonant mode, of microresonator system 100 by detecting one or more characteristics of output light 168 such as intensity, wavelength, and/or phase.

In some cases, a change in one or more characteristics of output light 168 can indicate the presence of an external agent, such as a scattering center 180 that can affect one or more characteristics of microresonator system 100. For example, if distance “t” between the scattering center and core 152 of optical microresonator 150 is sufficiently small, then optical coupling can occur between the microresonator and the scattering center. The optical coupling can change one or more characteristics of an excited resonant mode of microresonator system 100. For example, the optical coupling can change one or more characteristics of resonant mode 160 of microresonator 150. A change in mode 160 can lead to a change in one or more characteristics of guided mode 124 that exits optical waveguide 120 as output light 168. Detector 166 can detect the change in mode 160 or the resonant mode of microresonator system 100 by detecting a corresponding change in output light 168.

In the exemplary microresonator system 100 shown in FIG. 1, scattering center 180 is proximate microresonator 150. In general, scattering center 180 can be sufficiently close to any part of microresonator system 100 that can lead to a change in a characteristic of a resonant mode of the microresonator system. For example, the scattering center may be sufficiently close to microcavity 140 to allow optical coupling between the scattering center and the microcavity.

A change in the strength of optical coupling between scattering center 180 and microresonator 150 can induce a change in a characteristic of, for example, resonant mode 160. The change in the strength of optical coupling can be achieved by various means. For example, a change in the spacing “t” between scattering center 180 and microresonator 150 or core 152 can change the strength of optical coupling between the scattering center and the microresonator. As another example, a change in the index of refraction nₛ of the scattering center can change the strength of optical coupling between the scattering center and the microresonator. In general, any mechanism that can cause a change in the strength of optical coupling between scattering center 180 and microresonator 150 can induce a change in a characteristic of output light 168 and a resonant mode of the microresonator system.

In some cases, such as in the case of some metals such as gold, the real part of the index of refraction of the scattering center is less than 1 for wavelengths near 1550 nm. In some other cases, such as in the case of silicon, the real part of the index of refraction of the scattering center is greater than 1 for wavelengths near 1550 nm.

Examples of scattering centers that can be used as scattering center 180 include dielectric nanoparticlaes; semiconductor nanoparticles such as silicon nanoparticles; and metal nanoparticles such as gold and aluminum nanoparticles. In some cases, a scattering center may be a semiconductor such as Si, GaAs, InP, CdSe, or CdS. For example, a scattering center can be a silicon particle having a diameter of 80 nanometers and an index of refraction (the real part) of 3.5 for a wavelength of interest. Another example of a scattering center is a gold particle having a diameter of 80 nanometers and an index of refraction of 0.54+9.58i for wavelengths near 1550 nm. Another example of a scattering center is an aluminum particle having a diameter of 80 nanometers and an index of refraction of 1.44+16.0i for wavelengths near 1550 nm.

In some cases, the scattering center can be a dielectric particle. In some cases, the scattering center can be a non-fluorescent particle. In some cases, the scattering center is not a semiconductor.

In some cases, the size of scattering center 180 is no greater than about 1000 nanometers, or no greater than about 500 nanometers, or no greater than about 100 nanometers, or no greater than about 50 nanometers.

Microresonator system 100 can be used as a sensor, capable of sensing, for example, an analyte 182. For example, microresonator 150 may be capable of bonding with analyte 182. Such bonding capability may be achieved by, for example, a suitable treatment of the outer surface of microresonator 150 or core 152. In some cases, analyte 182 is associated with scattering center 180. Such an association can, for example, be achieved by attaching the analyte to the scattering center. The scattering center may be brought in optical proximity to microresonator 150 when analyte 182 bonds with the outer surface of the microresonator. The scattering center induces a change in a characteristic of resonant mode 160 which, in turn, results in a change in a characteristic of a resonant mode of the microresonator system. Optical detector 166 can detect the presence of analyte 182 by detecting the change in the characteristic of resonant mode 160 by monitoring changes in one or more characteristics of output light 168. In some cases, the induced change can be a frequency shift in mode 160. In such cases, optical detector 166 can detect the frequency shift by, for example, detecting a frequency shift in output light 168. Analyte 182 can, for example, include a protein, a virus, or a DNA molecule.

In some cases, analyte 182 can include a first antibody of an antigen that is to be detected. The first antibody can be associated with scattering center 180. A second antibody of the antigen can be associated with microresonator 150. The antigen facilitates a bonding between the first and second antibodies. As a result, the scattering center is brought into optical contact with the microresonator and induces a change in a characteristic of a resonant mode of the microresonator system. The detector can detect the presence of the scattering center, and therefore the antigen, by detecting the change in the characteristic. In some cases, the first antibody can be the same as the second antibody. Such an exemplary sensing process can be used in a variety of applications such as in food safety, food processing, medical testing, environmental testing, and industrial hygiene. In some cases, scattering center 180 can induce a frequency shift in resonant mode 160 and thereby in a corresponding resonant mode of the microresonator system, where the shift can be detected by detector 166.

In some cases, microresonator system 100 can be capable of detecting a change in the index of refraction of cladding layer 101. For example, cladding layer 101 may initially be air. With an air cladding, a resonant mode of the microresonator system can be at a resonant frequency f₁ which can result in an output light 168 at the resonant frequency f₁. A change in the index of refraction of cladding layer 101 can occur when, for example, the air cladding is replaced or mixed with, for example, a vapor, such as an organic vapor, a gas, a liquid, a biological or chemical material, or any other material that can result in a change in the index of refraction of cladding 101. The change in the index of refraction of cladding 101 can result in the resonant mode of the microresonator system and output light 168 shifting to a frequency f₂ where f₂ is different than f₁. Optical detector 166 can detect the frequency shift Δf=f₁-f₂.

In some cases, waveguide 120, microresonator 150, and microcavity 140 can be integrated onto a common substrate. The integration may be a monolithic integration, in which case the different components are all fabricated onto the common substrate typically using the same material systems. Such an integration can be substrate specific, meaning that the integration may be easier or feasible for some substrates and harder or not possible for some other substrates. For example, it may be possible to fabricate or grow the detector, the microresonator, the microcavity, and the waveguide onto a substrate, such as a Si substrate, but it may be difficult or not possible to grow or fabricate, for example, the light source onto the same substrate. As another example, it may be possible to grow or fabricate all the system components on a III-V semiconductor substrate such as an InP or GaAs substrate.

The integration can be a hybrid integration, in which case at least some of the components are first fabricated separately and then assembled onto a common substrate by, for example, using adhesive or solder bonding. In such a case, the microresonator, the microcavity, and the waveguide may be monolithically integrated onto the substrate. In some cases, the bonding may require active alignment of the light source and the detector with the waveguide.

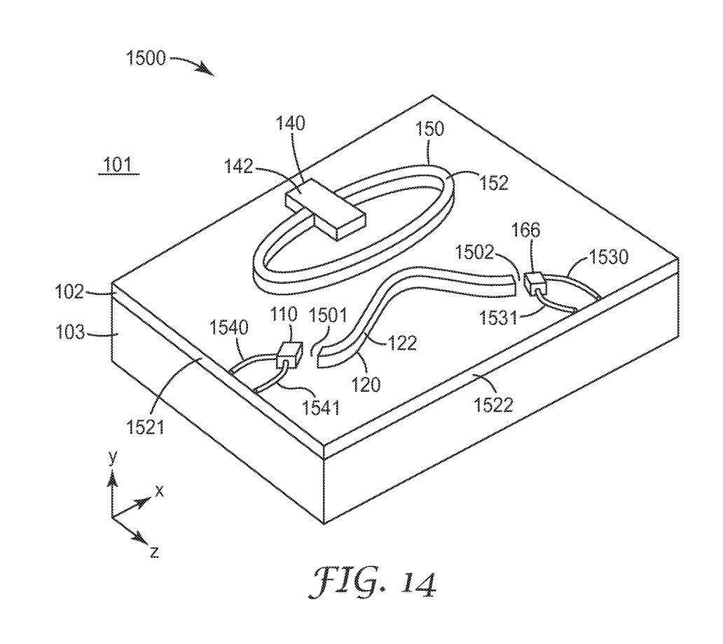

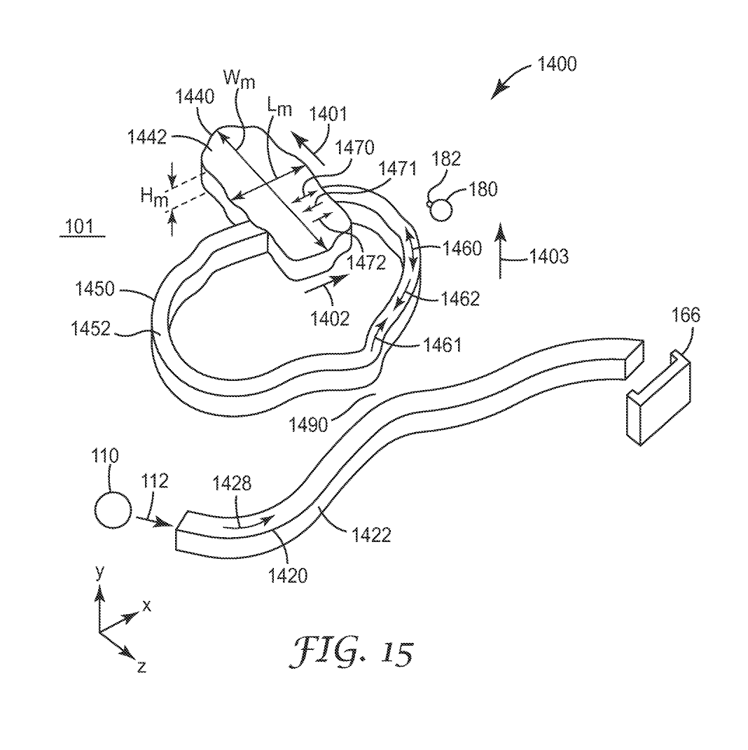

FIG. 14 shows a schematic three-dimensional view of an integrated optical device 1500. Light source 110 and detector 166 are integrated onto substrate 103 of optical device 1500. Waveguide 120, microcavity 140, and microresonator 150 have upper cladding 101 and lower cladding layer 102 and are integrated onto substrate 103. Light source 110 is separated from waveguide 120 by a gap 1501 and includes electric leads 1540 and 1541 integrated onto substrate 103. Electric leads 1540 and 1541 extend to an edge 1521 of optical device 1500 for connection to, for example, an external power source and/or a controller not shown in FIG. 14. Detector 166 is separated from waveguide 120 by a gap 1502 and includes electric leads 1530 and 1531 integrated onto substrate 103. Electric leads 1530 and 1531 extend to an edge 1522 of optical device 1500 for connection to, for example, an external power source and/or other electronics not shown in FIG. 14.

Substrate 103 can be rigid or flexible. Substrate 103 may be optically opaque or transmissive. The substrate may be polymeric, a metal, a semiconductor, or any type of glass. For example, substrate 103 can be silicon. As another example, substrate 103 may be float glass or it may be made of organic materials such as polycarbonate, acrylic, polyethylene terephthalate (PET), polyvinyl chloride (PVC), polysulfone, and the like.

Microresonator 150, microcavity 140, and optical waveguide 120 can be made using known fabrication techniques. Exemplary fabrication techniques include photolithography, printing, casting, extrusion, embossing, and etching, such as reactive ion etching or wet chemical etching. Different layers in microresonator system 100 can be formed using known methods such as sputtering, vapor deposition, flame hydrolysis, casting, or any other deposition method that may be suitable in an application.

In some cases, light source 110 can be a broadband light source emitting, for example, white light. In some cases, light source 110 can be a narrow-band light source such as a tunable narrow-linewidth laser source. In some cases, detector 166 can be a narrow-band detector or the detector can be a spectrally sensitive detector. For example, detector 166 can be a spectrum analyzer. In some cases, detector 166 can be a broadband detector.

FIG. 15 shows a schematic three-dimensional view of a microresonator system 1400 that includes an optical waveguide 1420 having a core 1422, an optical microresonator 1450 having a core 1452 that is optically coupled to waveguide 1420 in a coupling region 1490, and an optical microcavity 1440 having a core 1442 that is optically coupled to microresonator 1450 but not to waveguide 1420. In some cases, optical microcavity 1440 is capable of supporting primarily one or more resonant modes.

Optical microresonator 1450 is optically coupled to optical microcavity 1440 along a width direction 1401 and a thickness direction 1403 of microcavity core 1442 where thickness direction 1403 is orthogonal to width direction 1401. In the exemplary microresonator system 1400, thickness direction 1403 is along the y-axis and width direction 1401 is along the negative z-axis. The thickness and width directions define a length direction 1402 that is orthogonal to both the thickness and width directions. Length direction 1402 is along the x-axis. Microcavity core 1442 has a largest width dimension Wₘ along width direction 1401, and a largest thickness dimension Hₘ along thickness direction 1403, and a largest length dimension Lₘ along length direction 1402.

In some cases, Hₘ is not greater than Wₘ. In some cases, optical microcavity 1440 is capable of supporting primarily one or more resonant modes for the ratio Lₘ/Wₘ being no greater than about 10 as described in, for example, commonly-owned U.S. patent application Ser. No. 11/616338 having Attorney Docket No. 62681US002. In some other cases, optical microcavity 1440 is capable of supporting primarily one or more resonant modes for the ratio Lₘ/Wₘ being no greater than about 6, or no greater than about 4, or no greater than about 3, or no greater than about 2. In some other cases, optical microcavity 1440 is capable of supporting primarily one or more resonant modes for the ratio Lₘ/Wₘ being no greater than about 1, or no greater than about 0.8, or no greater than about 0.5, or no greater than about 0.3, or no greater than about 0.1.

In some cases, Lₘ is not greater than about 50 microns, or not greater than about 30 microns, or not greater than about 20 microns, or not greater than about 10 microns. In some other cases, Lₘ is not greater than about 5 microns, or not greater than about 3 microns, or not greater than about 2 microns, or not greater than about 1 micron. In some other cases, Lₘ is not greater than about 0.8 microns, or not greater than about 0.6 microns, or not greater than about 0.5 microns.

In some cases, optical microcavity 1440 is capable of primarily supporting no more than 100 resonant modes, or no more than 50 resonant modes, or no more than 20 resonant modes, or no more than 15 resonant modes, or no more than 10 resonant modes, or no more than 8 resonant modes, or no more than 5 resonant modes.

In some cases, optical microcavity 1440 is capable of primarily supporting at least one resonant mode, or at least 2 resonant modes, or at least 5 resonant modes, or at least 10 resonant modes. In some cases, optical microcavity 1440 is capable of primarily supporting a single resonant mode, or two resonant modes.

In some cases, microresonator system 1400 is designed to operate primarily in a wavelength range from about 0.3 microns to about 15 microns, or from about 0.3 microns to about 5 microns, or from about 0.3 microns to about 2 microns, or from about 0.4 microns to about 1.6 microns, or from about 0.6 microns to about 1.6 microns. In some cases, microresonator system 1400 is designed to operate primarily at about 633 nm, or at about 850 nm, or at about 980 nm, or at about 1310 nm, or at about 1550 nm, or at about 10,600 nm.

In some cases, a resonant mode of microcavity 1440, such as a resonant mode 1470, is a traveling-wave or primarily a traveling-wave. In some other cases, a resonant mode of microcavity 1440 is a standing-wave or primarily a standing-wave.

In some cases, a resonant mode of microresonator 1450 is capable of exciting a resonant mode of microcavity 1440. For example, a resonant mode 1460 of the microresonator can optically couple to and excite resonant mode 1470 of the microcavity. In some cases, a standing-wave mode of microresonator 1450 is capable of exciting a standing-wave mode of microcavity 1440. For example, a resonant standing-wave mode 1460 of the microresonator can optically couple to and excite a resonant standing-wave mode 1470 of the microcavity.

In some cases, standing-wave mode 1470 can result from optical interference between two traveling-wave modes traveling in different directions, such as first traveling-wave ode 1471 and second traveling-wave mode 1472. In some cases, standing-wave mode 1460 can result from optical interference between two traveling-wave modes traveling in different directions, such as first traveling-wave mode 1461 and second traveling-wave mode 1462.

In some cases, traveling-wave mode 1461 can optically couple to and excite primarily traveling-wave mode 1471 traveling in the same general direction, and traveling-wave mode 1462 can optically couple to and excite primarily traveling-wave mode 1472 where both modes travel in the same general direction, such as a clockwise direction. In such cases, excited traveling-wave modes 1471 and 1472 can optically interfere to form standing-wave mode 1470.

Light 112 from light source 110 can excite an optical guided mode 1428 of optical waveguide 1420. Mode 1428 is capable of coupling to optical microresonator 1450 by evanescent coupling via coupling region 1490 generally located between optical waveguide 1420 and microresonator 1450. Guided mode 1428 is capable of exciting a traveling-wave mode, such as traveling-wave mode 1461, of the microresonator at the same wavelength. Guided mode 1461 can excite, for example, traveling-wave mode 1471 resulting in the generation of traveling-wave mode 1472 and standing-wave mode 1470. Mode 1472 can in turn excite traveling-wave 1462. Traveling-wave modes 1462 and 1461 can interfere to form standing-wave mode 1460.

In some cases, guided mode 1461 at different wavelengths may primarily excite different standing-wave modes of microcavity 1440. For example, guided mode 1461 having a first wavelength λ₁ can primarily excite one standing-wave mode while the guided mode having a second wavelength λ₂ can primarily excite a different standing-wave mode of the microresonator.

In some cases, microcavity 1440 may be capable of supporting degenerate standing-wave modes, meaning that guided mode 1461 having a wavelength λ₃ can excite primarily two or more different standing-wave modes of the microcavity having the same wavelength λ₃.

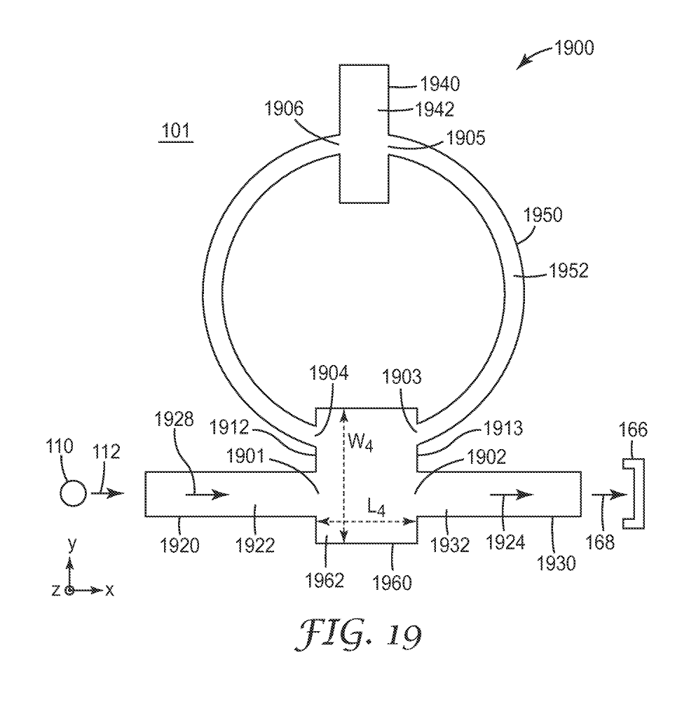

FIG. 19 shows a schematic top-view of an optical microresonator system that includes an input optical waveguide 1920 that has an optical core 1922 and is capable of supporting a guided mode 1928; an output optical waveguide 1930 that has an optical core 1932 and is capable of supporting a guided mode 1924; a first optical microcavity 1960 that is core coupled to input optical waveguide 1920 in a core coupling region 1901 and is core coupled to output optical waveguide 1930 in a core coupling region 1902; an optical microresonator 1950 that has an optical core 1952 and is core coupled to first optical microcavity at core coupling regions 1903 and 1904; and a second optical microcavity 1940 that has an optical core 1942 and is core coupled to optical microresonator 1950 at core coupling regions 1905 and 1906.

A core coupling region is generally the region where core coupling between two or more waveguides occurs. In some cases, such as when the cores of the two waveguides are of different materials, the core coupling region can include a physical interface which is the interface between the two cores. In some cases, such as when the two cores are made of the same material and form a unitary construction, the core coupling region does not include a physical interface between the two waveguides.

Input optical waveguide 1920 is in optical communication with light source 110 that emits input light 112. Output optical waveguide 1930 is in optical communication with detector 166 that receives output light 168 from output waveguide 1930.

Optical microresonator 1950 is core coupled to first optical microcavity 1960, but it is not core coupled to input waveguide 1920 and output waveguide 1930. First optical microresonator 1950 is directly coupled to first optical microcavity 1960 and is indirectly coupled, that is through first microcavity 1960, to input waveguide 1920 and to output waveguide 1930.

Second optical microcavity 1940 is core coupled to microresonator 1950 but it not core coupled to first optical microcavity 1960, input waveguide 1920 and output waveguide 1930. Second optical microcavity 1940 is directly coupled to microresonator 1950. Second optical microcavity 1940 is indirectly coupled, that is through microresonator 1950, to microcavity 1960.

In the exemplary microresonator system 1900, first optical microcavity 1960 is rectangular having a length L₄ along the x-direction and a width W₄ along the y-direction.

In some cases, first optical microcavity 1960 can be a multimode interference coupler (MMIC) described in, for example, Soldano et al., “Optical Multi-Mode Interference Devices Based on Self-Imaging: Principles and Applications”, Journal of Lightwave Technology 13(4), pp. 615-626, April 1995; and in, for example, commonly-owned U.S. patent application Ser. No. 11/616338 having Attorney Docket No. 62681US002. In some cases, MMIC 1960 is so designed that a traveling-wave mode of the microcavity propagating within the microcavity along, for example, the x-direction, suffers no or very little reflection at at least some of the boundaries of the microcavity, such as, for example, at sidewalls 1912 and 1913 of the microcavity.

In some cases, microcavity 1960 can support primarily two or more, or three or more, or five or more traveling-wave modes. In such cases, the ratio L₄/W₄ is no less than about 2, or no less than about 3, or no less than about 4, or no less than about 6, or no less than about 10. In some other cases, the ratio L₄/W₄ is no less than about 20, or no less than about 40, or no less than about 60, or no less than about 80, or no less than about 100.

In some cases, L₄ is greater than about 50 microns, or greater than about 100 microns, or greater than about 200 microns, or greater than about 500 microns. In some other cases, L₄ is greater than about 1000 microns, or greater than about 2000 microns, or greater than about 5000 microns, or greater than about 10,000 microns.

In some cases, optical microcavity 1960 is capable of primarily supporting at least 100 resonant modes, or at least 200 resonant modes, or at least 400 resonant modes, or at least 500 resonant modes, or at least 700 resonant modes, or at least 800 resonant modes, or at least 1000 resonant modes.

In some cases, first optical microcavity 1960 is an MMIC and second optical microcavity 1940 is not an MMIC. In such cases, microcavity 1960 can support at least 50 resonant modes and microcavity 1940 can support no more than 20 resonant modes, or microcavity 1960 can support at least 100 resonant modes and microcavity 1940 can support no more than 20 resonant modes, or microcavity 1960 can support at least 100 resonant modes and microcavity 1940 can support no more than 15 resonant modes, or microcavity 1960 can support at least 100 resonant modes and microcavity 1940 can support no more than 10 resonant modes, or microcavity 1960 can support at least 100 resonant modes and microcavity 1940 can support no more than 8 resonant modes, or microcavity 1960 can support at least 100 resonant modes and microcavity 1940 can support no more than 5 resonant modes.

Some of the advantages of the disclosed embodiments are further illustrated by the following examples. The particular materials, amounts and dimensions recited in these example, as well as other conditions and details, should not be construed to unduly limit the present invention.

### EXAMPLE 1

An optical device similar to microresonator system 100 of FIG. 1 was numerically analyzed using an effective two dimensional Finite Difference Time Domain (FDTD) approach. For the simulation, all the cores were silicon having a refractive index of 3.5 and an effective thickness of 0.4 microns. The optical microresonator was a ring having a 0.2 micron thickness and a 3.6 micron outer diameter. The spacing t₁ between cores 122 and 152 in coupling region 190 was 0.2 microns. Microcavity core 142 was a rectangular solid having a width W₁ of 1.8 microns and a length L₁ of 0.6 microns resulting in a ratio L₁/W₁ of about 0.33. Microcavity 140 was positioned symmetrically relative to ring microresonator 150 along the x-axis, meaning that the microcavity and the microresonator shared the same axis of symmetry along the y-axis. Distances d₁ and d₂ were each 0.8 microns. Upper cladding 101 was air having a refractive index of 1. Lower cladding 102 was silicon dioxide having a refractive index of 1.46.

In the simulation, light source 110 was a pulsed light source emitting light 112 in the form of a discrete 1 femtosecond long Gaussian pulse centered at 2 microns with a full width at half maximum (FWHM) of 1 micron. The broadband input pulses resulted in a wide spectrum response in the range from about 1 micron to about 3 microns detected by detector 166.

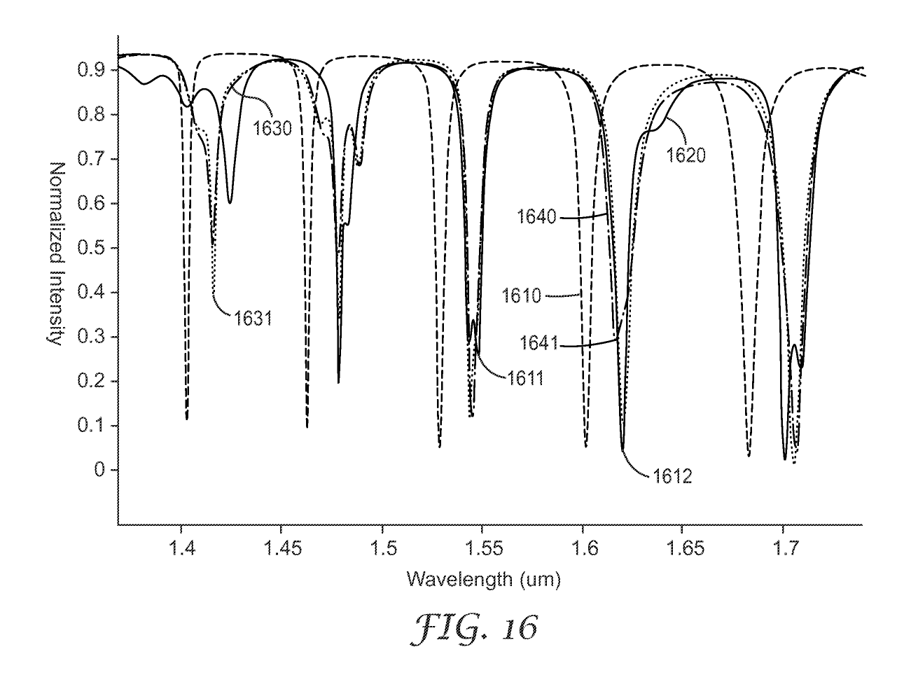

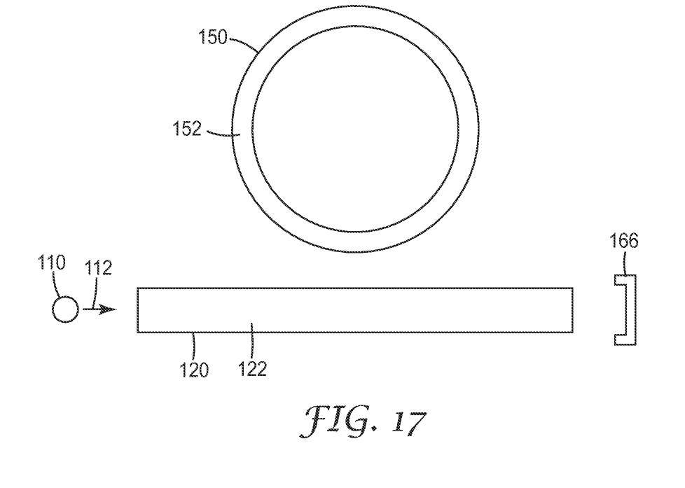

Curve 1620 in FIG. 16 shows the calculated signal strength (in arbitrary units relative to the intensity of input light) at detector 166 as a function of wavelength (in microns) in the absence of scattering center 180. Curve 1640 shows the calculated output signal strength in the presence of scattering center 180. The scattering center was a spherical gold particle having a diameter equal to 80 nanometers and a complex refractive index equal to 0.54+9.58i at about 1550 nm. The scattering center was placed along a horizontal axis of symmetry 191 of the microresonator passing through center 151 as shown schematically in FIG. 1. There was a gap “t” of 50 nanometers between the particle and the microresonator. FIG. 16 shows that the scattering center induced a shift in at least a number of resonant frequencies of the microresonator system. Curve 1620 shows that the optical device had several resonant frequencies such as a resonant frequency at location 1612 corresponding to about 1.62 microns. For comparison, curve 1610 shows the calculated signal strength at the detector for a reference optical device that was the same as the optical device of Example 1 except that the reference device, shown schematically in FIG. 17, did not include a microcavity.

FIG. 16 shows that that the inclusion of microcavity 140 resulted in a shift in the resonant frequencies of the optical device and a peak splitting at, at least, some of the resonant frequencies. For example, FIG. 16 shows a peak splitting at location 1611.

The two dimensional FDTD approach was used to verify that the microcavity supported primarily resonant modes. Light was launched in waveguide 120 at a resonant frequency of the optical device and the locations of electric field maxima within the microcavity were monitored as a function of time. The results showed that such locations were essentially stationary, thereby indicating that the microcavity supported primarily resonant standing-wave modes.

### EXAMPLE 2

An optical device similar to microresonator system of Example 1 was numerically analyzed using an effective two dimensional Finite Difference Time Domain (FDTD) approach except that the microcavity was shifted 0.2 microns along the positive y-axis resulting in d₁ being equal to 1.0 micron and d₂ being equal to 0.6 microns .

Curve 1630 in FIG. 16 shows the calculated signal strength at detector 166 in the absence of scattering center 180. Curve 1630 shows that the optical device had several resonant frequencies such as a resonant frequency at location 1631 corresponding to about 1.4 microns.

The two dimensional FDTD approach was used to verify that the microcavity supported primarily resonant modes. Light was launched in waveguide 120 at a resonant frequency of the optical device and the locations of electric field maxima within the microcavity were monitored as a function of time. The results showed that such locations were essentially stationary, thereby indicating that the microcavity supported primarily resonant standing-wave modes.

### EXAMPLE 3

An optical device similar to microresonator system 1300 of FIG. 13 was numerically analyzed using an effective two dimensional Finite Difference Time Domain (FDTD) approach. For the simulation, all the cores were silicon having a refractive index of 3.5 and an effective thickness of 0.4 microns. The optical microresonator was a ring having a 0.2 micron thickness and a 3.6 micron outer diameter. The spacing t₁ between cores 122 and 1352 in coupling region 1390 was 0.2 microns. Upper cladding 101 was air having a refractive index of 1. The lower cladding (similar to microresonator system 100) was silicon dioxide having a refractive index of 1.46.

Microcavity core 1342 was a rectangular solid having a width W₂ of 1.8 microns and a length L₂ of 0.6 microns resulting in a ratio L₂/W₂ of about 0.33. Microcavity 1340 was positioned asymmetrically relative to ring microresonator 1350 along the x-axis resulting in a distance k₂ equal to 0.4 microns. Distances d₃ and d₄ were each 0.8 microns.

Microcavity core 1362 was a rectangular solid having a width W₃ of 1.8 microns and a length L₃ of 0.3 microns resulting in a ratio L₃/W₃ of about 0.17. Microcavity 1360 was positioned asymmetrically relative to ring microresonator 1350 along the x-axis resulting in a distance k₃ equal to 0.25 microns. Distances d₅ and d₆ were each 0.8 microns.

In the simulation, light source 110 was a pulsed light source emitting light 112 in the form of a discrete 1 femtosecond long Gaussian pulse centered at 2 microns with a full width at half maximum (FWHM) of 1 micron. The broadband input pulses resulted in a wide spectrum response in the range from about 1 micron to about 3 microns detected by detector 166.

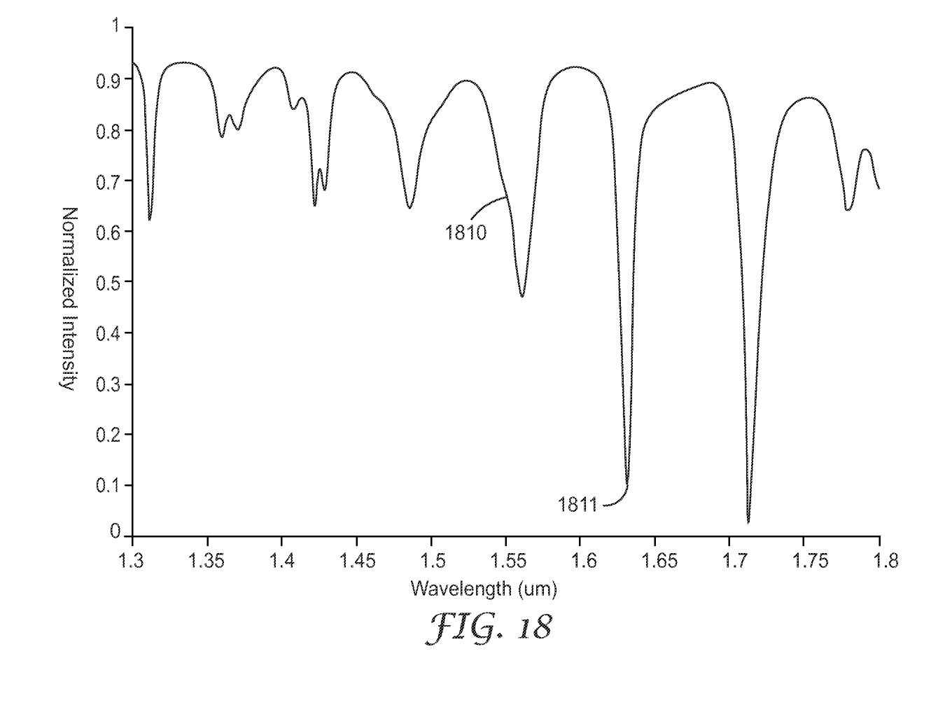

Curve 1810 in FIG. 18 shows the calculated signal strength (in arbitrary units relative to the intensity of input light) at detector 166 as a function of wavelength (in microns) in the absence of scattering center 180. Curve 1810 shows that the optical device had several resonant frequencies such as a resonant frequency at location 1811 corresponding to about 1.63 microns.

The two dimensional FDTD approach was used to verify that at least one of the two microcavities supported primarily resonant modes. Light was launched in waveguide 120 at a resonant frequency of the optical device and the locations of electric field maxima within the two microcavity were monitored as a function of time. The results showed that such locations were essentially stationary in each microcavity, thereby indicating that each microcavity supported primarily resonant standing-wave modes.

As used herein, terms such as “vertical”, “horizontal”, “above”, “below”, “left”, “right”, “upper” and “lower”, “clockwise” and “counter clockwise” and other similar terms, refer to relative positions as shown in the figures. In general, a physical embodiment can have a different orientation, and in that case, the terms are intended to refer to relative positions modified to the actual orientation of the device. For example, even if the construction in FIG. 14 is inverted as compared to the orientation in the figure, cladding 102 is still considered to be the “lower” cladding.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. An optical microresonator system comprising:
an optical waveguide;
an optical microresonator directly optically coupled to the optical waveguide; and
a first optical microcavity core coupled to the optical microresonator but not to the optical waveguide.

2. The optical microresonator system of claim 1, wherein the first optical microcavity is capable of supporting primarily one or more resonant modes.

3. The optical microresonator system of claim 2, wherein at least one of the one or more resonant modes is confined in two but not three dimensions.

4. The optical microresonator system of claim 2, wherein at least one of the one or more resonant modes is confined in three dimensions.

5. The optical microresonator system of claim 2, wherein at least one of the one or more resonant modes is primarily a traveling-wave.

6. The optical microresonator system of claim 2, wherein at least one of the one or more resonant modes is primarily a standing-wave.

7. The optical microresonator system of claim 1, wherein the optical waveguide is coupled to the optical microresonator by a core coupling.

8. The optical microresonator system of claim 1, wherein the optical waveguide is coupled to the optical microresonator by an evanescent coupling.

9. The optical microresonator system of claim 1, wherein the optical waveguide comprises an input face in optical communication with a light source and an output face in optical communication with a light detector.

10. The optical microresonator system of claim 1 further comprising a second optical microcavity core coupled to the optical microresonator but not to the optical waveguide.

11. The optical microresonator system of claim 10, wherein the second optical microcavity is capable of supporting primarily one or more resonant modes.

12. The optical microresonator system of claim 1, wherein the optical microresonator has an axis of symmetry that is parallel to an axis of symmetry of the optical microcavity.

13. The optical microresonator system of claim 12, wherein the axis of symmetry of the optical microresonator is collinear with the axis of symmetry of the optical microcavity.

14. The optical microresonator system of claim 1, wherein the optical microresonator is directly optically coupled to the optical waveguide in a coupling region, the optical microresonator having a first axis of symmetry generally directed at the coupling region.

15. The optical microresonator system of claim 14, wherein the optical microcavity has a second axis of symmetry that is parallel to the first axis of symmetry.

16. The optical microresonator system of claim 15, wherein the second axis of symmetry is collinear with the first axis of symmetry.

17. The optical microresonator system of claim 15, wherein the second axis of symmetry is laterally offset from the first axis of symmetry.

18. The optical microresonator system of claim 14, wherein no axis of symmetry of the optical microcavity is parallel to the first axis of symmetry.

19. The optical microresonator system of claim 1, wherein the optical microresonator is optically coupled to the optical microcavity along a width direction and a thickness direction of the microcavity core, the thickness direction being orthogonal to the width direction, the microcavity core having a largest width dimension W along the width direction, a largest thickness dimension H along the thickness direction, and a largest length dimension L along a length direction, the length direction being orthogonal to the width and thickness directions, H being no greater than W, L/W being no greater than about 6.

20. The optical microresonator system of claim 16, wherein L/W is no greater than about 1.

21. An optical sensor comprising:
a microresonator system comprising:
an optical waveguide;
an optical microresonator directly optically coupled to the optical waveguide; and
an optical microcavity optically coupled to the optical microresonator but not to the optical waveguide;
a light source in optical communication with the optical waveguide and emitting light at a wavelength corresponding to a first resonant mode of the microresonator system; and
a detector in optical communication with the microresonator system, the detector being detecting a characteristic of the first resonant mode, such that the characteristic of the first resonant mode changes when an analyte is brought proximate the microresonator system, the detector detecting the change.

22. The optical sensor of claim 21, wherein the optical microcavity supports primarily one or more resonant modes.

23. The optical sensor of claim 22, wherein each of the one or more resonant modes of the optical microcavity is a standing-wave mode.

24. The optical sensor of claim 21, wherein the characteristic comprises an intensity of the first resonant mode.

25. The optical sensor of claim 21, wherein the characteristic comprises a wavelength of the first resonant mode.

26. The optical sensor of claim 21, wherein the characteristic comprises a phase of the first resonant mode.

27. The optical sensor of claim 21, wherein the microresonator is optically coupled to the microcavity along a length of the microcavity, the microcavity having a length dimension L and a width dimension W, L/W being no greater than about 6.

28. The optical sensor of claim 27, wherein L/W is no greater than about 1.

29. An optical microresonator system comprising:
an optical waveguide supporting a guided mode;
an optical microresonator capable of supporting a first resonant mode that is directly excited by the guided mode; and
an optical microcavity capable of supporting a second resonant mode that is directly excited by the first resonant mode but not by the guided mode.

30. The optical microresonator system of claim 29, wherein the first resonant mode comprises a traveling-wave mode and the second resonant mode comprises a standing-wave mode.

31. The optical microresonator system of claim 29, wherein each of the first and second resonant modes comprises a standing-wave mode.

32. The optical microresonator system of claim 29, wherein the optical microcavity is a rectangular solid.

33. An optical microresonator system comprising:
an optical waveguide;
a first optical microcavity core coupled to the optical waveguide;
an optical microresonator core coupled to the first optical microcavity but not to the optical waveguide; and
a second optical microcavity core coupled to the optical microresonator but not to the first optical microcavity.

34. The optical microresonator system of claim 33, wherein the first but not the second optical microcavity is a multimode interference coupler.
